(19) United States
(12) Patent Application Publication
(10) Pub. No.: US 2011/0310976 A1
(43) Pub. Date: Dec. 22, 2011

(54) Joint Coding of Partition Information in Video Coding

(75) Inventors: Xianglin Wang, San Diego, CA (US); Wei-Jung Chien, San Diego, CA (US); Marta Karczewicz, San Diego, CA (US)

(73) Assignee: QUALCOMM Incorporated, San Diego, CA (US)

(21) Appl. No.: 13/162,466

(22) Filed: Jun. 16, 2011

Related U.S. Application Data
(60) Provisional application No. 61/355,656, filed on Jun. 17, 2010.

(51) Int. Cl. H04N 7/26

(52) U.S. Cl. 375/240.24; 375/240.25; 375/E07.027; 375/E07.176

(57) ABSTRACT

In one example, a video decoder is configured to receive a value for a coding unit of video data, wherein the coding unit is partitioned into a plurality of sub-coding units, determine whether the sub-coding units are partitioned into further sub-coding units based on the value, and decode the sub-coding units and the further sub-coding units. In another example, a video encoder is configured to partition a coding unit of video data into a plurality of sub-coding units, determine whether to partition the sub-coding units into further sub-coding units, and encode the coding unit to include a value that indicates whether the sub-coding units are partitioned into the further sub-coding units.

This application claims the benefit of U.S. Provisional Application No. 61/355,656, filed Jun. 17, 2010, which is incorporated herein by reference in its entirety.

### TECHNICAL FIELD

This disclosure relates to video coding, and more particularly, to syntax information for coded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into video blocks. Each video block can be further partitioned. Video blocks in an intra-coded (I) frame or slice are encoded using spatial prediction with respect to neighboring video blocks. Video blocks in an inter-coded (P or B) frame or slice may be encoded using spatial prediction with respect to neighboring video blocks in the same frame or slice, or using temporal prediction with respect to other reference frames.

### SUMMARY

In general, this disclosure describes techniques for coding partition information for blocks of coded video data. The techniques of this disclosure may improve efficiency for coding of partition information for blocks of video data used to code the blocks by jointly coding partition information for multiple blocks of video data. The techniques of this disclosure include jointly coding partition information for multiple blocks of video data using variable-length codewords having lengths inversely proportional to the likelihood of the partition information, e.g., based on coding contexts determined for the blocks. Additionally, the techniques of this disclosure include jointly coding partition information for multiple blocks of video data using run-length coding techniques, wherein the resulting run-length coded partition information is compressed relative to the original partition information for the blocks. In this manner, there may be a relative bit savings for a coded bitstream including the partition information for the multiple blocks of video data when using the techniques of this disclosure.

In one example, a method for decoding video data includes receiving a value for a coding unit of video data, wherein the coding unit is partitioned into a plurality of sub-coding units, determining whether the sub-coding units are partitioned into further sub-coding units based on the value, and decoding the sub-coding units and the further sub-coding units.

In another example, an apparatus for decoding video data includes a video decoder configured to receive a value for a coding unit of video data, wherein the coding unit is partitioned into a plurality of sub-coding units, determine whether the sub-coding units are partitioned into further sub-coding units based on the value, and decode the sub-coding units and the further sub-coding units.

In another example, an apparatus for decoding video data includes means for receiving a value for a coding unit of video data, wherein the coding unit is partitioned into a plurality of sub-coding units, means for determining whether the sub-coding units are partitioned into further sub-coding units based on the value, and means for decoding the sub-coding units and the further sub-coding units.

In another example, a computer program product includes a computer-readable medium having stored thereon instructions that, when executed, cause a programmable processor to receive a value for a coding unit of video data, wherein the coding unit is partitioned into a plurality of sub-coding units, determine whether the sub-coding units are partitioned into further sub-coding units based on the value, and decode the sub-coding units and the further sub-coding units.

In another example, a method of encoding video data includes partitioning a coding unit of video data into a plurality of sub-coding units, determining whether to partition the sub-coding units into further sub-coding units, and encoding the coding unit to include a value that indicates whether the sub-coding units are partitioned into the further sub-coding units.

In another example, an apparatus for encoding video data includes a video encoder configured to partition a coding unit of video data into a plurality of sub-coding units, determine whether to partition the sub-coding units into further sub-coding units, and encode the coding unit to include a value that indicates whether the sub-coding units are partitioned into the further sub-coding units.

In another example, an apparatus for encoding video data includes means for partitioning a coding unit of video data into a plurality of sub-coding units, means for determining whether to partition the sub-coding units into further sub-coding units, and means for encoding the coding unit to include a value that indicates whether the sub-coding units are partitioned into the further sub-coding units.

In another example, a computer program product includes a computer-readable medium having stored thereon instructions that, when executed, cause a processor to partition a coding unit of video data into a plurality of sub-coding units, determine whether to partition the sub-coding units into further sub-coding units, and encode the coding unit to include a value that indicates whether the sub-coding units are partitioned into the further sub-coding units.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a video encoding and decoding system that may implement techniques for jointly coding partition information for multiple blocks of video data.

FIG. 2 is a block diagram illustrating an example of a video encoder that may implement techniques for jointly encoding partition information for multiple blocks of video data.

FIG. 3 is a block diagram illustrating an example of a video decoder that may implement techniques for decoding jointly encoded partition information for multiple blocks of video data.

FIGS. 4A and 4B are conceptual diagrams illustrating an example of a block of video data and a corresponding quadtree data structure representing partition information for the block.

FIG. 5 is a flowchart illustrating an example method for jointly encoding partition information for multiple blocks of video data.

FIG. 6 is a flowchart illustrating an example method for decoding jointly encoded partition information for multiple blocks of video data.

### DETAILED DESCRIPTION

In general, this disclosure describes techniques for coding partition information for blocks of coded video data. The techniques of this disclosure may improve efficiency for coding partition information used to code blocks of video data. In this disclosure, “coding” generally refers both to encoding video data at the encoder and decoding the video data at the decoder. In accordance with examples of techniques of this disclosure, a video encoder may be configured to partition a block of video data into a plurality of sub-blocks, determine whether to partition the sub-blocks into further sub-blocks, and encode the block to include a value that indicates whether the sub-blocks are partitioned into the further sub-blocks.

In particular, the techniques of this disclosure are directed to encoding a value for a block, where the value is representative of partition information of a plurality of sub-blocks of the block. Thus, rather than coding individual split flags for each of the sub-blocks that indicate whether the sub-blocks are split (that is, partitioned), the techniques of this disclosure are directed to jointly coding the split flags using a single value. The single value may represent split flags for immediate sub-blocks of a block, and in some examples, may represent split flags for further sub-blocks of the immediate sub-blocks. Accordingly, the techniques of this disclosure may be applied to jointly code partition information for one or more levels of partitioned sub-blocks for a block. Likewise, this disclosure provides techniques for decoding values representing jointly coded split flags (that is, partition information) for one or more levels of sub-blocks of a block.

A video encoder may encode a value indicating partition information for sub-blocks of a block using a single variable length code (VLC) codeword selected from a VLC table. The video encoder may initially select the VLC table based on an encoding context determined for the block. The encoding context may include, for example, a partition level for the block, and/or partition information for neighboring blocks of the block, wherein the neighboring blocks may be located at a same partition level as the partition level for the sub-blocks. The neighboring blocks may include previously encoded blocks of the same frame or slice as the current block.

The selected VLC table may include a mapping of VLC codewords to values indicating partition information for the sub-blocks. In this manner, codewords that correspond to more likely values (i.e., corresponding to more likely partition information) may comprise fewer bits than codewords corresponding to less likely values. For example, a codeword corresponding to a most likely value may comprise only a single bit. As such, application of the techniques of this disclosure may yield a bitstream that more efficiently represents partition information in the most likely cases, based on context for blocks, than encoding the partition information for each of the sub-blocks individually, e.g., using a single bit flag for each one of the sub-blocks. In some examples, the video encoder may update the selected VLC table and/or the mapping of VLC codewords to values indicating partition information, based on statistics calculated for recently coded blocks.

Alternatively, the value indicating the partition information for the sub-blocks may be encoded using run-length coding (RLC) techniques. In this example, the video encoder may determine individual values (e.g., split flags) for each of the sub-blocks, arrange the split flags into a continuous array or string (or other similar data structure), then run-length code the array of split flags. The resulting RLC value may thereby indicate the partition information for the sub-blocks using fewer bits than the number of bits in the array. In any case, the video encoder may encode the block to include a single value indicating partition information for sub-blocks of the block in a manner that may achieve a relative bit savings, compared to encoding the partition information for each of the sub-blocks of the block individually.

A video decoder may be similarly configured, e.g., to perform similar techniques when determining partition information for sub-blocks of an encoded block of video data. In accordance with the techniques of this disclosure, a video decoder may be configured to receive a value for a block of video data, wherein the block is partitioned into a plurality of sub-blocks, determine whether the sub-blocks are partitioned into further sub-blocks based on the value, and decode the sub-blocks and the further sub-blocks.

As discussed above, the value indicating the partition information for the sub-blocks may comprise a single VLC codeword. The video decoder may select a VLC table to determine semantics associated with the codeword (namely whether the sub-blocks are partitioned) based on a decoding context determined for the block. As described above with reference to the video encoder, the determined decoding context may include a partition level for the block, and/or partition information for neighboring blocks of the block. Likewise, the neighboring blocks may be located at a same partition level as the partition level for the sub-blocks, and wherein the neighboring blocks may include previously decoded blocks.

Again as described above, the selected VLC table may include a mapping of VLC codewords to indications of partition information for the sub-blocks. The VLC tables may be constructed such that codewords that correspond to more likely partitioning schemes, based on the corresponding context, have fewer bits than codewords corresponding to less likely partitioning schemes for the corresponding context. The video decoder may determine whether any or all of the sub-blocks are partitioned using the semantics associated with the codeword by the VLC table. Additionally, as also described above, the video decoder may update the selected VLC table and/or the mapping of VLC codewords to indications of partition information based on statistics of recently decoded blocks to reflect which partitioning schemes are more or less likely to occur based on the respective context for the block.

As also described above, in other examples, the value indicating the partition information for the sub-blocks may comprise a run-length coded value. The video decoder may run-length decode the value to determine split flags for the sub-blocks, where the split flags indicate partition information for the sub-blocks. In any case, the video decoder may decode the sub-blocks and the further sub-blocks using the partition information for the sub-blocks.

For purposes of example, this disclosure refers to selecting a VLC table based on a coding context, which may include selecting between VLC tables with different assignments of VLC codewords to values indicating partition information for sub-blocks and/or different codewords. That is, in some examples, the codewords in two different VLC tables may be different, while in other examples, the codewords themselves may be the same but the partition information may be mapped to the codewords differently. Accordingly, it should be understood that either or both of VLC tables with different codewords and/or VLC codewords with different mappings may be selected. References to selecting a VLC table should be understood to include either or both of these possibilities. Similarly, this description generally describes examples of updating a selected VLC table based on statistics of recently coded blocks. However, it should be understood that updating the VLC table may include either or both of updating the codewords of the table and/or updating a mapping of the table. In general, references to manipulating a VLC table in this disclosure should be understood to include either or both of VLC tables and/or codeword mappings. Thus, the codewords of a VLC table may be updated (e.g., recalculated), and/or a mapping of partition information to codewords may be updated as well, or in the alternative.

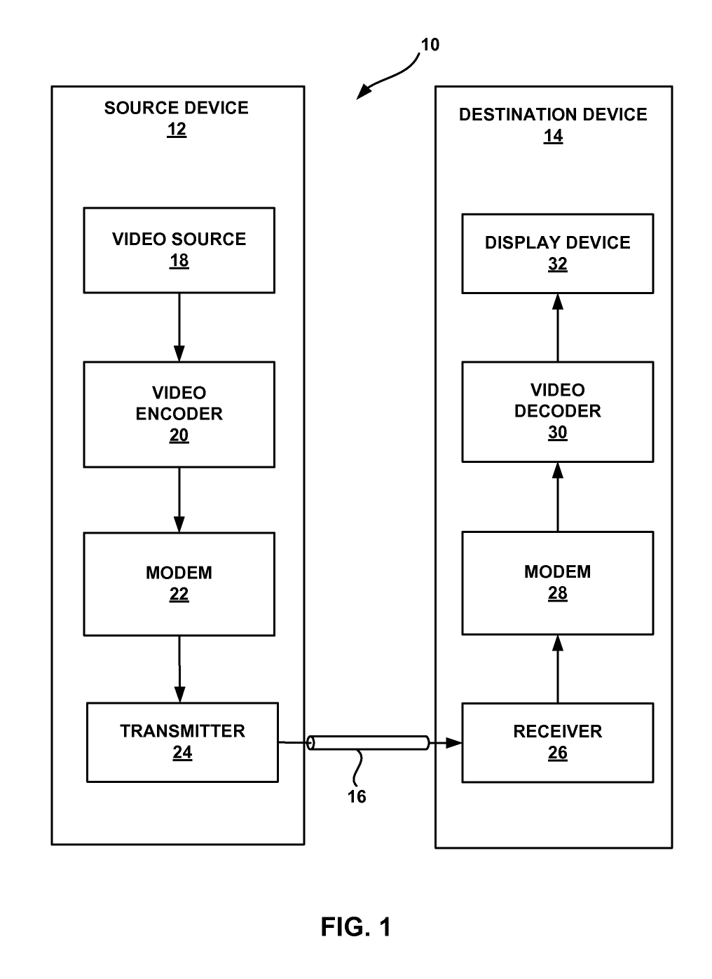

FIG. 1 is a block diagram illustrating an example of a video encoding and decoding system 10 that may implement techniques for jointly coding partition information for multiple blocks of video data. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

The techniques of this disclosure, however, which concern jointly coding syntax data representative of partition information for multiple blocks of video data, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 and/or video decoder 30 of destination device 14 may be configured to apply the techniques for jointly coding partition information for multiple blocks of video data. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for jointly coding partition information for multiple blocks of video data may be performed by any digital video encoding and/or decoding device. Although generally the techniques of this disclosure are performed by a video encoding device or a video decoding device, the techniques may also be performed by a video encoder/decoder, typically referred to as a “CODEC.” Source device 12 and destination device 14 are merely examples of such coding devices in which source device 12 generates coded video data for transmission to destination device 14. In some examples, devices 12, 14 may operate in a substantially symmetrical manner such that each of devices 12, 14 includes video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process described above may implement one or more of the techniques described herein to jointly code partition information for multiple blocks of video data. The information communicated over channel 16 may include syntax information defined by video encoder 20, which is also used by video decoder 30, that includes syntax elements that describe partitioning of blocks of video data, such as coding units. Video decoder 30 uses this partitioning information, as well as other data in the bitstream, to decode the encoded bitstream, and to pass the decoded information to display device 32. Display device 32, in turn, displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. In general, the techniques of this disclosure are described with respect to the upcoming High Efficiency Video Coding (HEVC) standard, but it should be understood that these techniques may be used in conjunction with other video coding standards as well. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder and decoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. According to the ITU-T H.264 standard, a video block may correspond to a macroblock or a partition of a macroblock. According to HEVC, a video block may correspond to a coding unit (e.g., a largest coding unit), or a partition of a coding unit. In accordance with the techniques of this disclosure, a block may be partitioned, e.g., into four square, non-overlapping sub-blocks. For example, a CU having a size of 2N×2N pixels may be partitioned into four non-overlapping N×N pixel sub-blocks. Each video frame may include a plurality of slices, i.e., portions of the video frame. Each slice may include a plurality of video blocks (e.g., largest coding units), each of which may be partitioned, also referred to as sub-blocks or sub-coding units (sub-CUs).

Depending on the specified coding standard, video blocks may be partitioned into various “N×N” sub-block sizes, such as 16×16, 8×8, 4×4, 2×2, and so forth. Video encoder 20 may partition each sub-block recursively, that is, partition a 2N×2N block into four N×N blocks, and may partition any or all of the N×N blocks into four (N/2)×(N/2) blocks. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As one example, in the ITU-T H.264 standard, blocks that are 16 by 16 pixels in size may be referred to as macroblocks, and blocks that are less than 16 by 16 pixels may be referred to as partitions of a 16 by 16 macroblock. In other standards, blocks may be defined more generally with respect to their size, for example, as coding units and partitions thereof, each having a varying size, rather than a fixed size.

Video blocks may comprise blocks of pixel data in the pixel domain, or blocks of transform coefficients in the transform domain, e.g., following application of a transform, such as a discrete cosine transform (DCT), an integer transform, a wavelet transform, or a conceptually similar transform to residual data for a given video block, wherein the residual data represents pixel differences between video data for the block and predictive data generated for the block. In some cases, video blocks may comprise blocks of quantized transform coefficients in the transform domain, wherein, following application of a transform to residual data for a given video block, the resulting transform coefficients are also quantized.

In general, video encoder 20 partitions a block into sub-blocks when the block includes high-frequency changes or other high amounts of detail. Using smaller blocks to code video data may result in better prediction for blocks that include high levels of detail, and may therefore reduce the resulting error (i.e., deviation of the prediction data from source video data), represented as residual data. However, each block of video data typically includes a block header including information used to decode the block. Thus, although smaller blocks may yield lower residual values for the blocks, the benefits of using small blocks may be outweighed by the overhead of the header data for the small blocks, in some cases. Accordingly, video encoder 20 may be configured to perform a rate-distortion optimization process, in which video encoder 20 attempts to determine an optimal (or acceptable) partitioning scheme that balances the reduction in error (residual data or distortion) with the overhead (bit rate) associated with each of the blocks.

In general, video blocks include both parent blocks and partitions thereof (i.e., sub-blocks). In addition, a slice may be considered to be a plurality of video blocks, such as a set of largest coding units, any or all of which may be partitioned into sub-coding units that may be further partitioned. Each slice may correspond to an independently decodable unit of video data. Alternatively, frames themselves may correspond to decodable units, or other portions of a frame may be defined as decodable units. The term “coded unit” may refer to any independently decodable unit of video data, such as an entire frame, a slice of a frame, a group of pictures (GOP) also referred to as a sequence, or other independently decodable unit defined according to applicable coding techniques.

Efforts are currently in progress to develop a new video coding standard, currently referred to as High Efficiency Video Coding (HEVC). The emerging HEVC standard may also be referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-four intra-prediction encoding modes, e.g., based on the size of a block being intra-prediction coded.

HM refers to a block of video data as a coding unit (CU). A CU may refer to a 2N×2N pixel image region that serves as a basic unit to which various coding tools are applied for compression. A CU is conceptually similar to macroblocks of H.264/AVC. Syntax data within a bitstream may define a largest coding unit (LCU), which is a largest CU in terms of the number of pixels for a particular unit (e.g., a slice, frame, GOP, or other unit of video data including LCUs). In general, a CU has a similar purpose to a macroblock of H.264, except that a CU does not have a size distinction. Thus, in general, any CU may be partitioned, or “split” into sub-CUs. In some cases, syntax data defines a maximum partition depth for an LCU, which may in turn restrict the smallest sized CU that can occur for a particular coded unit.

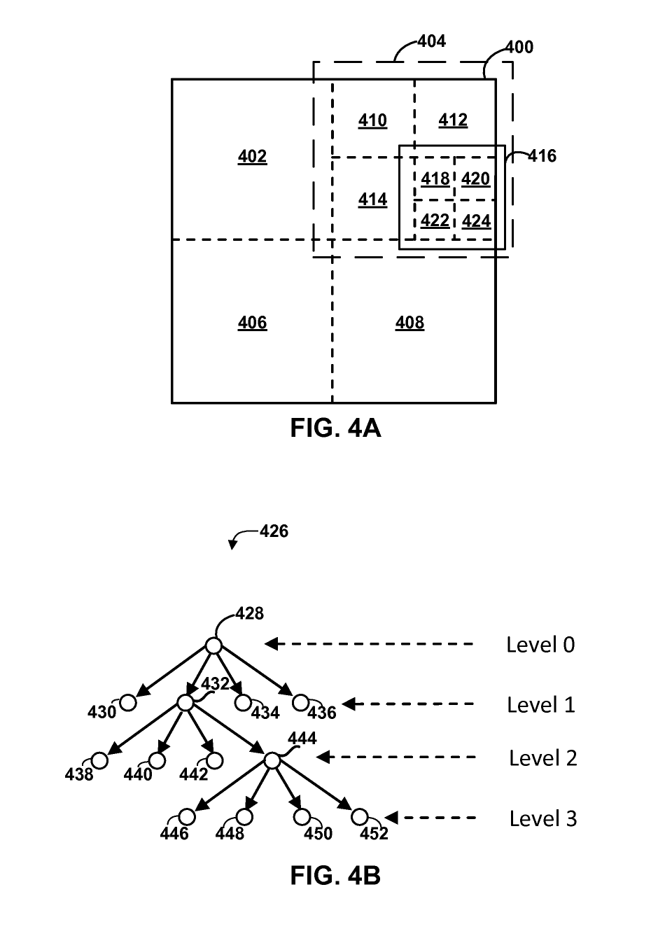

To achieve better coding efficiency, a CU may be further partitioned into smaller size CUs according to a quadtree structure, as described in greater detail below. As shown in FIG. 4A, described in greater detail below, a CU may be non-split, or it may be split into four square, non-overlapping sub-CUs, wherein such splitting can also be performed recursively. Recently, with the focus of video coding shifted toward high definition video, large sized CUs, e.g. 64×64 or 128×128, have been introduced to achieve better coding efficiency. This disclosure provides techniques for improving the efficiency with which partition information is signaled. In particular, rather than providing individual split flags for each CU, this disclosure provides techniques for jointly coding partition information (e.g., split flags) for a plurality of CUs.

In some examples, video encoder 20 may calculate split flags per conventional HEVC techniques, e.g., determining a value for a split flag of a CU indicating whether the CU is split (partitioned) into sub-CUs. For a parent CU that is split into four sub-CUs, video encoder 20 may determine values for split flags for the sub-CUs, and then select a variable length code (VLC) codeword representative of the split flags for the sub-CUs. Alternatively, video encoder 20 may run-length encode the split flags to form a run-length coded value. Generally, video encoder 20 may represent the split flags for the sub-CUs with a single, common value (e.g., a run length code or a VLC codeword, in these examples). Other techniques for jointly coding split flags of the sub-CUs may also be used.

FIG. 4A, described in greater detail below, illustrates a CU partitioned into sub-CUs at various partition levels. For example, FIG. 4A shows a CU 400 (at level 0) split into four smaller CUs 402, 404, 406, and 408 (at level 1). Among the four smaller CUs, CUs 402, 406 and 408 are not further split. FIG. 4A further shows CU 404 split down to level 2 (with level 2 CUs denoted in dashed lines within CU 404). One of the level 2 CUs, CU 416, is further split into four level 3 sub-CUs 418, 420, 422, and 424. The techniques of this disclosure are premised on a correlation, discovered during empirical testing, between the context for a block and the manner in which sub-blocks of the block are partitioned. These techniques may take advantage of this discovered correlation to improve bitstream efficiency with respect to coded partition information.

In general, references in this disclosure to a CU may refer to an LCU of video data, or a sub-CU of an LCU. An LCU may be split into sub-CUs, and each sub-CU may be further split into sub-CUs, and so forth. Syntax data for a bitstream may define a maximum number of times an LCU may be split, which may be referred to as CU partition level, or CU “depth.” Accordingly, a bitstream may also define a smallest coding unit (SCU). This disclosure also uses the term “block” to refer to any of a CU, a prediction unit (PU) of a CU, or a transform unit (TU) of a CU (PUs and TUs are described in greater detail below).

An LCU may be associated with a quadtree data structure that indicates how the LCU is partitioned. FIG. 4B, discussed in greater detail below, illustrates an example of a quadtree 426 that corresponds to LCU 400 of FIG. 4A. In general, a quadtree data structure includes one node per CU of an LCU, where a root node corresponds to the LCU, and other nodes correspond to sub-CUs of the LCU. If a given CU is split into four sub-CUs, the node in the quadtree corresponding to the split CU includes four child nodes, each of which corresponds to one of the sub-CUs. Each node of the quadtree data structure may provide syntax information for the corresponding CU. For example, a node in the quadtree may include a split flag for the CU, indicating whether the CU corresponding to the node is split into four sub-CUs. Syntax information for a given CU may be defined recursively, and may depend on whether the CU is split into sub-CUs. In accordance with the techniques of this disclosure, partition information for sub-CUs may be provided, e.g., in a node of the quadtree corresponding to a parent CU of the sub-CUs, or in a node corresponding to one of the sub-CUs (e.g., a first one of the sub-CUs), as a single value that jointly represents split flags for the sub-CUs. The value may further represent a split flag for the parent CU, and/or split flags for further sub-CUs of the sub-CUs.

A CU that is not split (i.e., a CU corresponding a terminal, or “leaf” node in a given quadtree) may include one or more prediction units (PUs). In general, a PU represents all or a portion of the corresponding CU, and includes data for retrieving a reference sample for the PU for purposes of performing prediction for the CU. For example, when the CU is intra-mode encoded, the PU may include data describing an intra-prediction mode for the PU. As another example, when the CU is inter-mode encoded, the PU may include data defining a motion vector for the PU. The data defining the motion vector may describe, for example, a horizontal component of the motion vector, a vertical component of the motion vector, a resolution for the motion vector (e.g., half pixel precision or one-quarter pixel precision or one-eighth pixel precision), a reference frame to which the motion vector points, and/or a reference list (e.g., list 0 or list 1) for the motion vector. Data for the CU defining the one or more PUs of the CU may also describe, for example, partitioning of the CU into the one or more PUs. Partitioning modes may differ between whether the CU is uncoded, intra-prediction mode encoded, or inter-prediction mode encoded.

A CU having one or more PUs may also include one or more transform units (TUs). Following prediction for a CU using one or more PUs, as described above, a video encoder may calculate one or more residual blocks for the respective portions of the CU corresponding to the one of more PUs. The residual blocks may represent a pixel difference between the video data for the CU and the predicted data for the one or more PUs. Video encoder 20 may transform, quantize, and scan coefficients of the TUs to define a set of quantized transform coefficients. A leaf-node CU may further include a transform quadtree that defines partitioning of TUs for the CU, where the transform quadtree may indicate partition information for the transform coefficients that is substantially similar to the quadtree data structure described above with reference to a CU. A TU is not necessarily limited to the size of a PU. Thus, TUs may be larger or smaller than corresponding PUs for the same CU. In some examples, the maximum size of a TU may correspond to the size of the corresponding CU.

Following intra-predictive or inter-predictive encoding to produce predictive data and residual data, and following any transforms (such as the 4×4 or 8×8 integer transforms, similar to those used in H.264/AVC, or a discrete cosine transform DCT) to produce transform coefficients, video encoder 20 may quantize the transform coefficients. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to context adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information, such as coded block pattern (CBP) values, macroblock type, coding mode, maximum macroblock size for a coded unit (such as a frame, slice, macroblock, or sequence), or the like. According to some coding standards, such syntax information may include block partition information, e.g., represented using a quadtree data structure, as previously described. For example, for a given block, the syntax information may include partition information indicating whether the block is partitioned into sub-blocks. As another example, for each of the sub-blocks of the block, the syntax information may include partition information indicating whether the sub-blocks are partitioned into further sub-blocks.

According to the current disclosure, video encoder 20 may jointly code partition information of CUs at a common partition level. In some examples, video encoder 20 may first perform a conventional process of assigning values to split flags to each of the CUs of an LCU. Then, video encoder 20 may jointly code the split flags from a number of neighboring CUs using variable length codes (VLCs). Video encoder 20 may be configured with a plurality of VLC tables corresponding to various contexts for CUs, e.g., partition level information for the CU, and/or whether neighboring CUs are partitioned. These VLC tables may be configured based on relative likelihoods of partitioning of sub-CUs for a CU, where the context may correspond to the relative likelihoods that the sub-CUs are partitioned. Accordingly, in general, the techniques of this disclosure may yield bit rate savings in the average case.

In case of quadtree-structured partitioning, as described above, one example of such grouping is that whenever a CU is split into four quarter sized CUs, the partition information of the four quarter-sized CUs is grouped and coded together. As shown in FIG. 4A, sub-CUs 402, 404, 406, and 408 represent four level 1 CUs. Sub-CUs 410, 412, 414, and 416 represent four of the sixteen possible level 2 CUs. According to the techniques of this disclosure, video encoder 20 may jointly code the partition information of sub-CUs 402, 404, 406 and 408. Similarly, video encoder 20 may jointly code the partition information of sub-CUs 410, 412, 414, and 416. It should be understood that, depending on partition level, different VLC tables and/or VLC codeword mappings may be used. That is, as discussed above, CU 400 may correspond to a different context (namely, different partition level) than CU 404. Therefore, video encoder 20 may include different VLC tables and/or different VLC codeword mappings for these different contexts to use to jointly code the partition information for the respective sub-CUs.

With variable length codes, compression may be achieved by using shorter code words to represent partitioning schemes of sub-CUs that occur more frequently for a particular context for a parent CU including the sub-CUs. For example, it may be determined that four sub-CUs resulting from partitioning an LCU have a high likelihood of being split. Therefore, a VLC table used to represent split flags for four sub-CUs of an LCU may have a relatively short codeword assigned to the case where all four sub-CUs are partitioned.

As discussed above, video encoder 20 may use partition information from neighboring CUs that were previously coded and at the same partition level as context for coding partition information of current CUs. FIG. 4A illustrates an example in which video encoder 20 may use whether neighboring CUs are partitioned as context information for a current CU in jointly coding partition information for sub-CUs of the current CU. In this example, sub-CUs 418, 420, 422, and 424 of sub-CU 416 may represent sub-CUs of current CU 416. Sub-CUs 410, 412, and 414 may represent neighboring CUs that are already coded. According the current disclosure, video encoder 20 may use partition information from sub-CUs 410, 412, and 414 as context information when for coding partition information for sub-CUs 418, 420, 422, and 424 of sub-CU 416. More specifically, depending on the binary partition values for sub-CUs 410, 412, and 414, video encoder 20 may select different VLC tables when jointly coding the partition information for sub-CUs 418, 420, 422, and 424 of sub-CU 416. Although not shown in FIG. 4A, any or all of CUs 410, 412, and 414 may be partitioned into sub-CUs, and those sub-CUs may be further partitioned into sub-CUs as well. Accordingly, video encoder 20 may treat whether neighboring CUs are partitioned as context information. Likewise, based on the context, video encoder 20 may select a VLC table and/or a VLC codeword mapping. Then, video encoder 20 may jointly code the partition information for sub-CUs 418, 420, 422, and 424 of CU 416, e.g., by selecting a codeword from the selected VLC table representative of the partitioning of sub-CUs 418, 420, 422, and 424.

It should be mentioned that for context purpose, if a CU is non-split at a certain partition level, all of its corresponding child CUs at further partition levels are also considered non-split. One such example is shown in FIG. 4A, where CU 416 may represent a current CU, and CU 414 may represent a neighboring CU to CU 416. Furthermore, CU 414 may be unsplit. Video encoder 20 may be configured to treat partitioning of neighboring CUs having the same size as sub-CUs 418, 420, 422, and 424 as context information for jointly coding the partition information for sub-CUs 418, 420, 422, and 424. It can be seen that, in this case, neighboring CU 414 would not include sub-CUs under the assumption that CU 414 there is not partitioned, and therefore, there would not be partition information coded for sub-CUs of CU 414. However, in this case, since parent CU 414 is non-split, it may be assumed that, for the purpose of determining context information for jointly coding partitioning information for sub-CUs 418, 420, 422, and 424, sub-CUs of CU 414 are all non-split.

Again, the techniques of this disclosure are based in part on a determined correlation of partition information among neighboring CUs. For example, when sub-CUs 412 and 414 are all split into smaller CUs (not shown), it may be determined that likely that CU 416 is also split into sub-CUs 418, 420, 422, and 424. Likewise, if sub-CUs 412 and 414 are non-split, it may be determined to be likely that CU 416 is not split (not shown) as well. For this reason, partition information of neighboring CUs may be used as context in improving the efficiency of coding the partition information of current CUs.

To reduce the number of possible contexts (and hence, the number of VLC tables mapped to the contexts), different values of the split flag grouping from neighboring CUs may be mapped to the same context (e.g., the same VLC table). For example, a first context may refer to the case when all of the binary partition flags from neighboring CUs are equal to “0.” A second context may refer to the case when all of the binary partition flags from the neighboring CUs are equal to “1.” A third context may refer to the case where all of the binary partition flags from the neighboring CUs are equal to other values.

Besides neighboring partition information, other factors may also be used as context. Such factors include, but are not limited to, partition depth etc. Additionally, depending on the statistics of binary partition values that have been coded, the mapping between a binary partition grouping (which consists of 4 binary partition flags in the example above) and variable length codes in a table may be updated or adjusted on the fly, i.e., during coding of CUs. For example, while groups of binary partition values are being coded, the number of occurrences for each different group value may be accumulated. After coding a certain number of such groups, the mapping between group values and variable length codes in a table may be adjusted according to the accumulated statistics of different group values. More frequently occurred group values may be assigned shorter code words.

In some examples of this disclosure, binary partition information (e.g., split flags) from each CU may be coded with using run length coding. That is, video encoder 20 may group and run length code the binary partition information from neighboring CUs at a certain partition level. RLC is a coding scheme that uses variable length code to represent different length of “runs,” e.g., a continuous sequence of ‘1’s or ‘0’s. In the present disclosure, a run may indicate how many consecutive CUs have the same binary partition information (e.g., are all split or are all non-split).

As an example relative to FIG. 4A, the sixteen possible CUs at partition level 2 may be indexed from 1 to 16 according to a zig-zag scan order. It should be noted that in practice, other scan orders, such as a raster scan order and a “Z” scan order, can also be used. Based on a given scan order, a one dimensional array of binary partition flags can be formed. Then, video encoder 20 may use RLC coding to code the one dimensional array of binary values. Such RLC coding of binary partition flags from neighboring CUs according to a certain scan order can be performed at any partition level, which may include run length coding multiple partition levels jointly using the same RLC coded value. Alternatively, such RLC coding of binary partition flags can be combined with the coding scheme described above. For example, RLC coding may be used only for partition level 0 (i.e. the largest size CU), while the scheme of grouping and jointly VLC coding flags based on a quadtree may be used for other partition levels.

In accordance with the techniques of this disclosure, syntax information for a given block of video data comprising partition information indicating whether the block is partitioned into sub-blocks may be jointly coded with corresponding syntax information of other blocks. As one example, video encoder 20 of source device 12 may encode blocks of video data (e.g., one or more CUs). Video encoder 20 may be configured to partition a CU of video data during the encoding process into a plurality of sub-CUs, which may include determining whether to partition the sub-CUs into further sub-CUs. Video encoder 20 may further be configured to encode the CU to include a value that indicates the partitioning scheme for the CU, e.g., whether the CU is partitioned and, if so, whether sub-CUs of the partitioned CU are partitioned into the further sub-CUs. Video encoder 20 may encode the value indicating the partition information for the sub-CUs using a single codeword selected from a VLC table. In other examples, video encoder 20 may encode the value indicating the partition information for the sub-CUs using RLC techniques.

In cases where VLC techniques are used to encode the value, as described above, video encoder 20 may also be configured to determine an encoding context for the CU used to select a particular VLC table and/or codeword mapping. The context may include various characteristics of the CU, such as, for example, partition level, or depth, for the CU, and whether any neighboring CUs of the CU are partitioned, e.g., whether an above-neighboring CU and a left-neighboring CU, or other neighboring CUs, of the CU are partitioned.

In some examples, the context may depend on whether neighboring CUs located at a same level as sub-CUs of the CU are partitioned. In general, the neighboring CUs of the CU may comprise previously encoded CUs. Video encoder 20 may use the determined context to select the VLC table and/or codeword mapping. Video encoder 20 may further select a codeword from the selected VLC table corresponding to the value indicating the partition information for the sub-CUs. Additionally, for the selected VLC table, video encoder 20 may update the mapping of codewords to values indicating partition information for sub-CUs of a CU based on the value to reflect which values are more or less likely to occur for the determined encoding context. For example, video encoder 20 may maintain counts for the number of combinations of partitioning schemes for a particular context, and set the codewords associated with each partitioning scheme such that the codewords have lengths that are inversely proportional to the likelihood of the schemes.

In cases where RLC techniques are used to encode the value, video encoder 20 may be configured to form a set of split flags for the sub-CUs of the CU, wherein the split flags indicate whether the respective sub-CUs are partitioned, and encode the set of split flags using RLC techniques to form an RLC code. In general, video encoder 20 may determine the number of continuous split flags with the same value in the set of split flags, and represent the number of same-valued split flags in the RLC code.

In any case, video encoder 20 may encode the CU including the value indicating the partition information for the sub-CUs of the CU. Because using either of the VLC or RLC coding techniques described above may, in the average case, result in the partition information for the sub-CUs being represented using fewer bits than individually encoding the partition information for the sub-CUs, there may be a relative bit savings for a coded bitstream including the jointly coded partition information in accordance with the techniques of this disclosure.

Video decoder 30 of destination device 14 may ultimately receive encoded video data (e.g., one or more CUs) from video encoder 20, e.g., from modem 28 and receiver 26. In accordance with one example of the techniques of this disclosure, video decoder 30 may be configured to receive a value for a CU of video data, wherein the CU is partitioned into a plurality of sub-CUs, determine whether the sub-CUs are partitioned into further sub-CUs based on the value, and decode the sub-CUs and the further sub-CUs. As described above with reference to video encoder 20, the value may comprise a codeword selected from a VLC table by a video encoder. As also described above, in other examples, the value may comprise an RLC code.

In examples where the value comprises a VLC codeword, video decoder 30 may be configured to determine a decoding context for the CU in a manner substantially similar to that used by video encoder 20, as previously described, to select a particular VLC table containing the codeword. For example, the decoding context may include various characteristics of the CU such as, for example, partition level, or depth, for the CU, and whether neighboring CUs of the CU are partitioned, e.g., whether an above-neighboring CU and a left-neighboring CU, or other neighboring CUs, of the CU are partitioned. In some examples, the context may depend on whether neighboring CUs located at a same partition level as the current CU are partitioned.

Using the selected VLC table, video decoder 30 may determine whether the sub-CUs of the CU are partitioned into the further sub-CUs based on the codeword. Moreover, video decoder 30 may update the selected VLC table based on the determination to reflect which determinations are more or less likely to occur for the determined decoding context, e.g., to coordinate the mapping with the mapping in the VLC table used by video encoder 20 to encode the CU.

Furthermore, in cases where the value comprises an RLC code, video decoder 30 may decode the value using RLC techniques described above with reference to video encoder 20 to determine whether the sub-CUs are partitioned into the further sub-CUs. For example, video decoder 30 may be configured to decode the RLC code to produce a set of split flags for the sub-CUs, and determine whether the sub-CUs are partitioned into the further sub-CUs based on the respective split flags for the sub-CUs.

In any case, video decoder 30 may decode the sub-CUs and the further sub-CUs based on the determined partition information for the sub-CUs of the CU. Once again, because using either of the VLC or RLC coding techniques described above may result in the value comprising fewer bits than when receiving individually encoded partition information for the sub-CUs, there may be a relative bit savings for a coded bitstream including the partition information when using the techniques of this disclosure.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Encoders and decoders may include components substantially similar to either or both of video encoder 20 and video decoder 30 may be included in one or more encoders or decoders, either of which may be integrated as part of a combined video encoder/decoder (CODEC). An apparatus including components substantially similar to video encoder 20 and/or video decoder 30 may comprise an integrated circuit, a microprocessor, and/or a wireless communication device, such as a cellular telephone.

In this manner, source device 12 represents an example of a device include including a video encoder configured to partition a coding unit of video data into a plurality of sub-coding units, determine whether to partition the sub-coding units into further sub-coding units, and encode the coding unit to include a value that indicates whether the sub-coding units are partitioned into the further sub-coding units.

Similarly, destination device 14 represents an example of a device including a video decoder configured to receive a value for a coding unit of video data, wherein the coding unit is partitioned into a plurality of sub-coding units, determine whether the sub-coding units are partitioned into further sub-coding units based on the value, and decode the sub-coding units and the further sub-coding units.

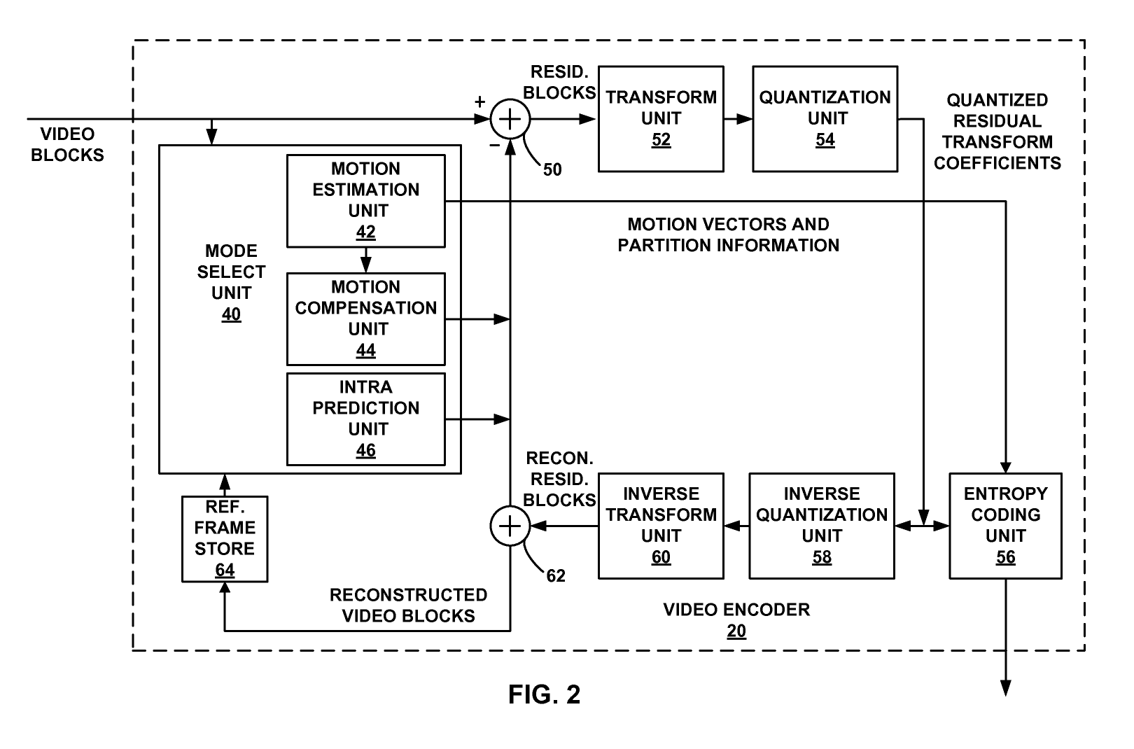

FIG. 2 is a block diagram illustrating an example of a video encoder 20 that may implement techniques for jointly encoding partition information for multiple blocks of video data. Video encoder 20 may perform intra- and inter-coding of blocks within video frames, including macroblocks or CUs, or partitions or sub-partitions thereof. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes, and inter-modes, such as uni-directional prediction (P-mode) or bi-directional prediction (B-mode), may refer to any of several temporal-based compression modes.

As shown in FIG. 2, video encoder 20 receives a current block of video data within a video frame to be encoded. In the example of FIG. 2, video encoder 20 includes motion compensation unit 44, motion estimation unit 42, intra prediction unit 46, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks (e.g., LCUs). Motion estimation unit 42 and motion compensation unit 44 may perform inter-predictive coding of a given received video block relative to one or more blocks in one or more reference frames to provide temporal compression. Intra prediction unit 46 may perform intra-predictive coding of a given received video block relative to one or more neighboring blocks in the same frame or slice as the block to be coded to provide spatially-based prediction values for encoding the block.

Mode select unit 40 may select one of the coding modes, intra or inter, e.g., based on error results and based on a frame or slice type for the frame or slice including the given received block being coded, and provide the resulting intra- or inter-coded block to summer 50 to generate residual block data and to summer 62 to reconstruct the encoded block for use in a reference frame or reference slice. In general, intra-prediction involves predicting a current block relative to neighboring, previously coded blocks, while inter-prediction involves motion estimation and motion compensation to temporally predict the current block.

Motion estimation unit 42 and motion compensation unit 44 represent the inter-prediction elements of video encoder 20. Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In general, a motion vector may describe motion of a CU, though in some cases (e.g., when a CU is coded using merge mode), the CU may inherit motion information from another CU. Motion compensation may involve fetching or generating the predictive block based on the motion vector determined by motion estimation. Again, motion estimation unit 42 and motion compensation unit 44 may be functionally integrated, in some examples.

Motion estimation unit 42 may calculate a motion vector for a video block of an inter-coded frame by comparing the video block to video blocks of a reference frame in reference frame store 64. Motion compensation unit 44 may also interpolate sub-integer pixels of the reference frame, e.g., an I-frame or a P-frame, for the purposes of this comparison. The ITU H.264 standard, as an example, describes two lists: list 0, which includes reference frames having a display order earlier than a current frame being encoded, and list 1, which includes reference frames having a display order later than the current frame being encoded. Therefore, data stored in reference frame store 64 may be organized according to these lists.

Motion estimation unit 42 may compare blocks of one or more reference frames from reference frame store 64 to a block to be encoded of a current frame, e.g., a P-frame or a B-frame. When the reference frames in reference frame store 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in reference frame store 64 if no values for sub-integer pixel positions are stored in reference frame store 64. Motion estimation unit 42 may send the calculated motion vector to entropy coding unit 56 and motion compensation unit 44. The reference frame block identified by a motion vector may be referred to as an inter-predictive block, or, more generally, a predictive block. Motion compensation unit 44 may calculate prediction data based on the predictive block.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes for each mode, and intra-prediction unit 46 (or mode select unit 40, in some examples) may select an appropriate intra-prediction mode to use from the tested modes. For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

As described above, an LCU may be split into sub-CUs, and each sub-CU may be further split into sub-CUs, and so forth. In some examples, for each possible partition of an LCU into sub-CUs, and for each non-split CU under the LCU partition, motion estimation unit 42 may determine a cost associated with each inter prediction mode for the non-split CU, and intra-prediction unit 46 may determine a cost associated with each intra-prediction mode for the non-split CU. These units may encode each non-split CU using various modes and determine an appropriate prediction mode for the CU. The cost may be calculated based on rate-distortion. Such a mode determination process based on rate-distortion cost is called rate-distortion optimization. Based on the best rate-distortion cost for each non-split CU, a best total rate-distortion cost can be calculated for an LCU for each possible partition of the LCU into sub-CUs. Based on such best total costs, best values for split flags associated with each CU in the LCU can be determined. As described below, mode selection unit 40 may provide the determined split flags to entropy coding unit 56, which may jointly code the split flags for multiple CUs, e.g., four CUs corresponding to sub-CUs of a parent CU.

After predicting a current block, e.g., using intra-prediction or inter-prediction, video encoder 20 may form a residual video block by subtracting the prediction data calculated by motion compensation unit 44 or intra-prediction unit 46 from the original video block being coded. Summer 50 represents the component or components that may perform this subtraction operation. Transform unit 52 may apply a transform, such as a discrete cosine transform (DCT) or a conceptually similar transform, to the residual block, producing a video block comprising residual transform coefficient values. Transform unit 52 may perform other transforms, such as those defined by the H.264 standard or used in HEVC, which are conceptually similar to DCT. Wavelet transforms, integer transforms, sub-band transforms, Karhunen-Loeve Transforms (KLTs), directional transforms, or other types of transforms could also be used. In any case, transform unit 52 may apply the transform to the residual block, producing a block of residual transform coefficients. The transform may convert the residual information from a pixel domain to a transform domain, such as a frequency domain. Quantization unit 54 may quantize the residual transform coefficients to further reduce bit rate. The quantization process may reduce the bit depth associated with some or all of the coefficients. The degree of quantization may be modified by adjusting a quantization parameter.

Following quantization, entropy coding unit 56 may entropy code the quantized transform coefficients. For example, entropy coding unit 56 may perform context adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of CABAC, context may be based on neighboring blocks and/or block sizes. In the case of CAVLC, context may be based on various characteristics of a coded block of video data and of previously coded neighboring blocks.

In some cases, entropy coding unit 56 or another unit of video encoder 20 may be configured to perform other coding functions, in addition to entropy coding as described above. For example, entropy coding unit 56 may be configured to determine coded block pattern (CBP) values for the blocks and partitions. Also, in some cases, entropy coding unit 56 may perform run length coding of the coefficients in a CU. In particular, entropy coding unit 56 may apply a zig-zag scan or other scan pattern to scan the transform coefficients in a CU and encode runs of zeros for further compression. Entropy coding unit 56 also may construct header information with appropriate syntax elements for transmission in the encoded video bitstream. According to some coding standards, such as HEVC, such syntax elements may include block partition information, e.g., represented using a quadtree data structure, as previously described. For example, for a given block to be encoded, the syntax elements may include partition information indicating whether the block is partitioned into sub-blocks. As another example, for each of the sub-blocks of the block, the syntax elements may include partition information indicating whether the sub-blocks are partitioned into further sub-blocks.

In accordance with the techniques of this disclosure, syntax information for a given block of video data comprising partition information indicating whether the block is partitioned into sub-blocks may be jointly coded with corresponding syntax information of other blocks. For example, video encoder 20 may be configured to partition a CU of video data into a plurality of sub-CUs, determine whether to partition the sub-CUs into further sub-CUs, and encode the CU to include a value that indicates whether the sub-CUs are partitioned into the further sub-CUs. In this manner, the value may represent partitioning information for each of the sub-CUs. In some examples, the value may represent partitioning information of further sub-CUs, when at least one of the sub-CUs is partitioned into further sub-CUs.

In some examples, motion estimation unit 42 or intra prediction unit 46 provides partition information to entropy coding unit 56. Entropy coding unit 56 may, in turn, select a codeword representative of the partition information for a plurality of CUs. In this manner, entropy coding unit 56 may jointly encode partition information for a plurality of sub-CUs.

As discussed above, in some examples, the partition information for the sub-CUs may be determined as part of generating prediction data for the CU, e.g., by mode select unit 40 in conjunction with one or more of motion estimation unit 42, motion compensation unit 44, and intra prediction unit 46. Generally, the partition information may correspond to a partition structure (also referred to as a partition scheme) selected for the CU by mode select unit 40, or by another component of video encoder 20, to minimize residual data generated for the CU using the prediction data for the CU, while maintaining an acceptable bit rate used to encode the CU, as described above. In any case, entropy coding unit 56 may encode the partition information for the sub-CUs using a single codeword selected from a VLC table. Alternatively, entropy coding unit 56 may run-length encode the partition information for the sub-CUs.

In cases where VLC techniques are used to encode the value, as described above, entropy coding unit 56 may also be configured to determine an encoding context for the CU used to select a particular VLC table for coding the partitioning information of the sub-CUs. The encoding context may include various characteristics of the CU such as, for example, partition level, or depth, for the CU, and/or whether any neighboring CUs of the CU are partitioned, e.g., whether an above-neighboring CU and a left-neighboring CU, or other neighboring CUs, of the CU are partitioned. In some examples, the encoding context may depend on whether neighboring CUs located at a same level as the CU are partitioned. In some examples, the neighboring CUs of the CU may comprise previously encoded CUs. Entropy coding unit 56 may use the determined encoding context to select the particular VLC table. Entropy coding unit 56 may further select a codeword from the selected VLC table corresponding to the value indicating the partition information for the sub-CUs. Additionally, for the selected VLC table, entropy coding unit 56 may update the mapping of codewords to values indicating partition information for sub-CUs of a CU based on the value to reflect which values are more or less likely to occur.

Table 1 illustrates an example VLC table that may be used in accordance with the techniques of this disclosure, wherein the table includes a mapping of partition information values for four sub-CUs of a CU (shown in columns “Sub-CU Partition Information Value”), indicating whether the sub-CUs are partitioned into further sub-CUs, to VLC codewords (shown in column “Codeword”) used to represent the corresponding partition information values. It should be noted that Table 1 includes only an excerpt from, or a subset of, such a VLC table, wherein the full VLC table would ordinarily include 16 different entries of partition information values mapped to 16 different VLC codewords, to represent all possible partition information values for the four sub-CUs of the CU, in this example.

In the example of Table 1, it is assumed that the codeword represents partition information for four sub-CUs of a common parent CU. In the example of Table 1, with reference to columns “Sub-CU Partition Information,” a value of “1” indicates that the corresponding sub-CU is partitioned into further sub-CUs, and a value of “0” indicates that the sub-CU is not partitioned. In other examples, different values may be used for a given VLC table to indicate whether sub-CUs of a CU are partitioned into further sub-CUs.

TABLE 1

Sub-CU Partition Information

| CU1 | CU2 | CU3 | CU4 | Codeword |
|---|---|---|---|---|
| 1 | 1 | 1 | 1 | 1 |
| 0 | 0 | 0 | 0 | 01 |
| . . . | . . . | . . . | . . . | . . . |

With reference to the example of Table 1, suppose that for a current CU of video data, the selected partition structure for the CU indicates that the CU is partitioned into four sub-CUs, and that all four of the sub-CUs of the CU are partitioned into further sub-CUs. In this example, assuming that a sub-CU being partitioned into further sub-CUs is indicated with a value of ‘1,’ as described above, mode selection unit 40 may provide split flags for four sub-CUs of a parent CU, each of the split flags having values indicating that the sub-CUs are split (e.g., ‘1’). The example of Table 1 is further premised on the assumption that the case where all sub-CUs for a CU are partitioned is the most likely case for the CU given the encoding context determined for the CU (i.e., the encoding context that was used to select the VLC table depicted in Table 1). Accordingly, in this example, entropy coding unit 56 would select the codeword “1” to represent the values of the split flags for the sub-CUs of the CU.

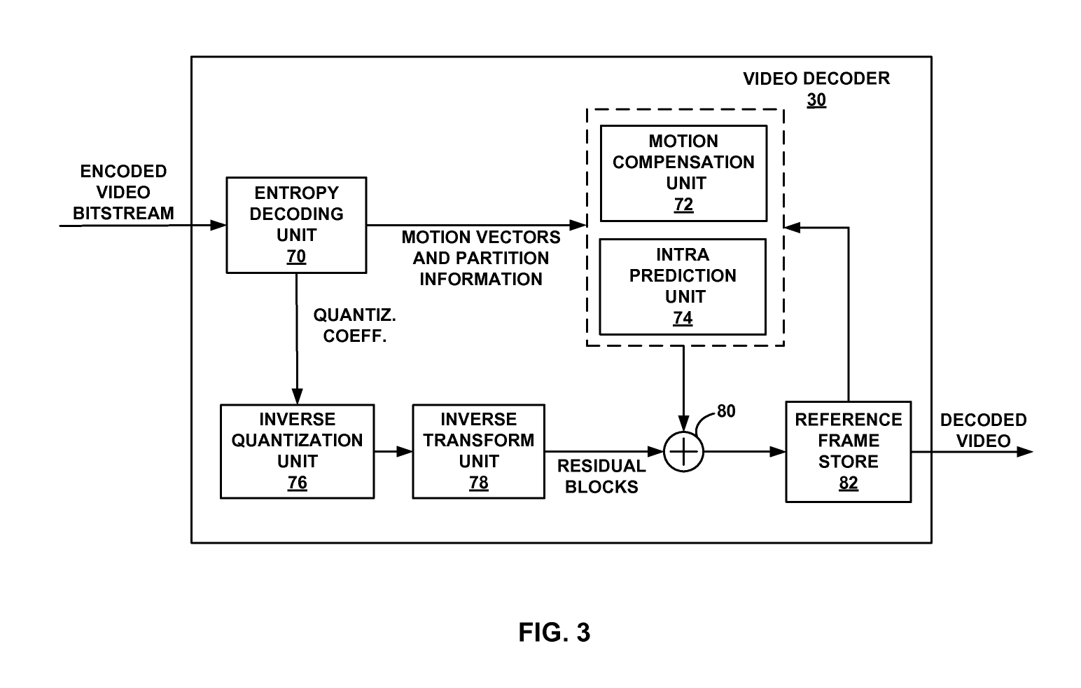

Referring briefly to video decoder 30 of FIG. 3, which is discussed in greater detail below, video decoder 30 may ultimately receive the value, namely the codeword “1.” Accordingly, video decoder 30 decode the codeword using a substantially similar VLC table as the VLC table depicted in Table 1, to determine partition information for four sub-CUs of a current CU. Using Table 1, video decoder 30 may determine that each of the four sub-CUs is partitioned into further sub-CUs. In this example, a bit savings may be achieved, due to the resulting codeword having a single bit, rather than four bits used to individually indicate whether the sub-CUs of the CU are partitioned into the further sub-CUs.

It should be understood that Table 1 is merely an example of a VLC table used to encode the partition information for the sub-CUs of the CU. The mapping of the VLC table in Table 1 is provided as an example of one of many possible mappings that may exist for a given VLC table used according to the techniques of this disclosure. As shown in Table 1, the partitioning scheme corresponding to all sub-CUs of the CU being partitioned is mapped to a shortest codeword in the VLC table, indicating that the corresponding partition scheme is determined to be the most likely partition schemes among the 16 possibilities defined by the VLC table for this coding context. In other examples, other partition scheme may be determined to be the most likely (e.g., partition scheme indicating that none of the sub-CUs is partitioned). Moreover, different VLC tables may provide different mappings, based on the determined encoding context for the CU. Accordingly, for different VLC tables selected, the corresponding mapping, indicating relative likelihood of different partition schemes, may vary, and, for a given VLC table selected, the mapping may be continuously updated based on partition information for sub-CUs of one or more previously encoded CUs.

In some examples, multiple encoding contexts determined for a given CU of video data, as described above, may correspond to a common VLC table. Accordingly, partition information for sub-CUs of respective CUs having different determined encoding contexts may nevertheless be encoded using a common VLC table, which may reduce system complexity and coding resources.

For purposes of example, Table 1 above utilizes unary codewords to represent partition information for sub-CUs of a CU. However, other types of variable length codes may be used in other examples. For example, certain codewords in a VLC table may have similar bit lengths, e.g., when probabilities of partition information for sub-CUs of a CU are approximately the same. Furthermore, any set of codewords may be used for a VLC table, so long as each of the codewords is uniquely decodable (e.g., none of the codewords is a prefix of another codeword in the same VLC table).

In cases where RLC techniques are used to encode the value, entropy coding unit 56 may be configured to form a set of split flags for the sub-CUs of the CU, wherein the split flags indicate whether the respective sub-CUs are partitioned, e.g., in a substantially similar manner as the values in columns “Sub-CU Partition Information Value” of Table 1, and encode the set of split flags to form an RLC code. For example, suppose that for a current CU of video data, the selected partition structure for the CU indicates that the CU is partitioned into sixteen sub-CUs, and that all of the sixteen sub-CUs of the CU are partitioned into further sub-CUs. In this example, assuming that a sub-CU being partitioned into further sub-CUs is indicated with a value of ‘1,’ as described above, entropy coding unit 56 may form a value of “1111111111111111” to represent the corresponding partition information for the sixteen sub-CUs. The value may be viewed as a sequence comprising sixteen consecutive binary data elements of value “1.” Accordingly, entropy coding unit 56 may run length encode the sequence which may result in using fewer bits, rather than sixteen bits of the original value, to encode the value.

In any case, entropy coding unit 56 may be configured to encode the CU to include a value that jointly represents partition information for a plurality of sub-CUs, such that the value indicates whether the sub-CUs are partitioned into the further sub-CUs. For example, entropy coding unit 56 may include the value as part of encoded syntax information for the CU using the VLC or RLC coding techniques described above. Because using either of the VLC or RLC coding techniques may result in the value being represented using fewer bits than when individually coding the partition information for the sub-CUs, there may be a relative bit savings for a coded bitstream including the partition information according to the techniques of this disclosure.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to calculate sub-integer pixel values of a predictive block for use in motion estimation. Summer 62 adds the reconstructed residual block to the motion compensated prediction block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

In this manner, video encoder 20 represents an example of a video encoder configured to partition a CU of video data into a plurality of sub-CUs, determine whether to partition the sub-CUs into further sub-CUs, and encode the CU to include a value that indicates whether the sub-CUs are partitioned into the further sub-CUs.

FIG. 3 is a block diagram illustrating an example of a video decoder 30 that may implement techniques for decoding jointly encoded partition information for multiple blocks of video data. In the example of FIG. 3, video decoder 30 includes an entropy decoding unit 70, motion compensation unit 72, intra prediction unit 74, inverse quantization unit 76, inverse transformation unit 78, reference frame store 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70. Intra prediction unit 74 may generate prediction data based on an intra-prediction mode received from entropy decoding unit 70 for a corresponding CU (or TU thereof).

Video decoder 30 may receive encoded video data (e.g., one or more CUs) encoded by, e.g., video encoder 20. In accordance with the techniques of this disclosure, as one example, video decoder 30 may be configured to receive a value for a CU of video data, wherein the CU is partitioned into a plurality of sub-CUs, determine whether the sub-CUs are partitioned into further sub-CUs based on the value, and decode the sub-CUs and the further sub-CUs. As described above with reference to video encoder 20, the value may comprise a codeword selected from a VLC table by a video encoder. In examples where the value comprises a VLC codeword, entropy decoding unit 70 may be configured to determine a decoding context for the CU in a manner substantially similar to that of video encoder 20, as previously described, and to select a VLC table based on the decoding context.

For example, the decoding context may include various characteristics of the CU such as, for example, partition level, or depth, for the CU, and/or whether any neighboring CUs of the CU are partitioned, wherein the neighboring CUs of the CU may be located at a same partition level as the partition level for the CU, and wherein the neighboring CUs may comprise previously decoded CUs. Using the selected VLC table, entropy decoding unit 70 may determine whether the sub-CUs of the CU are partitioned into the further sub-CUs based on the received codeword, and decode the sub-CUs and the further sub-CUs. Moreover, entropy decoding unit 70 may update the selected VLC table based on the determination to reflect which determinations are more or less likely to occur for the determined decoding context, e.g., to coordinate the mapping with a mapping in a VLC table used by the video encoder to encode the block of video data.

As an example, again with reference to the VLC table of Table 1, suppose that a value for a CU of video data received by video decoding unit 30 comprises a codeword “1.” In this example, entropy decoding unit 70 may use the codeword and the VLC table depicted in Table 1 to determine partition information for sub-CUs of the CU. In particular, Table 1 indicates, for this example, that the codeword “1” represents each sub-CU of the CU being partitioned. Accordingly, video decoder 30 may determine that, for a CU having a context corresponding to Table 1, and for a codeword having the value “1” for the CU, that sub-CUs of the CU are each partitioned into further sub-CUs.

On the other hand, for examples where the value comprises an RLC code, entropy decoding unit 70 may be configured to run-length decode the value to produce a set of split flags for the sub-CUs, and determine whether the sub-CUs are partitioned into the further sub-CUs based on the respective split flags for the sub-CUs. For example, entropy decoding unit 70 may decode a RLC code to produce a set of split flags “1010000010000,” representing the corresponding partition information for sub-CUs of the CU.

In any case, video decoder 30 may decode the sub-CUs and further sub-CUs based on the determined partition information for the sub-CUs of the CU. For example, motion compensation unit 72 or intra-prediction unit 74 may use the determined partition information to generate prediction data for the sub-CUs and the further sub-CUs used to decode the respective blocks. Once again, because using either of the VLC or RLC coding techniques described above may result in the value comprising fewer bits than when receiving individually encoded partition information for the sub-CUs, there may be a relative bit savings for a coded bitstream including the partition information when using the techniques of this disclosure.

Motion compensation unit 72 may use motion vectors received in the bitstream to identify a prediction block in reference frames in reference frame store 82. Intra prediction unit 74 may use intra prediction modes received in the bitstream to form a prediction block from spatially adjacent blocks.

Intra-prediction unit 74 may use an indication of an intra-prediction mode for the encoded block to intra-predict the encoded block, e.g., using pixels of neighboring, previously decoded blocks. For examples in which the block is inter-prediction mode encoded, motion compensation unit 72 may receive information defining a motion vector, in order to retrieve motion compensated prediction data for the encoded block. In any case, motion compensation unit 72 or intra-prediction unit 74 may provide information defining a prediction block to summer 80.

Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard or as performed by the HEVC Test Model. The inverse quantization process may also include use of a quantization parameter QP_{Y} calculated by encoder 50 for each block to determine a degree of quantization and, likewise, a degree of inverse quantization that should be applied.

Inverse transform unit 58 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information for the encoded block to determine sizes of blocks used to encode frame(s) of the encoded video sequence, partition information that describes how each block of a frame or slice of the encoded video sequence is partitioned, modes indicating how each partition is encoded, one or more reference frames (and reference frame lists) for each inter-encoded block or partition, and other information to decode the encoded video sequence. As described above, according to the techniques of this disclosure, such syntax information relating to partition information that describes how a given block of a frame or slice of the encoded sequence of video data is partitioned may be jointly coded for multiple blocks of the video data, and used by motion compensation unit 72 as described herein. Intra-prediction unit 74 may also use the syntax information for the encoded block to intra-predict the encoded block, e.g., using pixels of neighboring, previously decoded blocks, as described above.

Summer 80 sums the residual blocks with the corresponding prediction blocks generated by motion compensation unit 72 or intra-prediction unit 74 to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

In this manner, video decoder 30 of FIG. 3 represents an example of a video decoder configured to receive a value for a CU of video data, wherein the CU is partitioned into a plurality of sub-CUs, determine whether the sub-CUs are partitioned into further sub-CUs based on the value, and decode the sub-CUs and the further sub-CUs.

FIGS. 4A and 4B are conceptual diagrams illustrating an example of a block of video data and a corresponding quadtree data structure representing partition information for the block. As shown in FIG. 4A, a block of video data, e.g., a CU, may be partitioned into one of more sub-blocks, e.g., sub-CUs. With respect to the example of FIG. 4A, CU 400 (which may represent an LCU) may be partitioned into sub-CUs, including sub-CUs 402, 404, 406, and 408. Assume, for this example, that CU 400 has a size of 2N×2N pixels. Accordingly, sub-CUs 402, 404, 406, and 408 may have a size of N×N pixels.

Similarly, sub-CU 404 may be partitioned into four further sub-CUs, including sub-CUs 410, 412, 414, and 416, wherein each further sub-CU may have a size of N/2×N/2 pixels. Sub-CUs 410, 412, 414, and 416 are also considered sub-CUs of CU 400. Likewise, sub-CU 416 may be partitioned into four still further sub-CUs, including sub-CUs 418, 420, 422, and 424, wherein each of sub-CUs 418, 420, 422, and 424 may have a size of N/4×N/4 pixels, and so forth. Accordingly, CU 400, in this example, may be partitioned into a plurality of sub-CUs, wherein each of the sub-CUs may be partitioned into further sub-CUs. In some examples, a CU may be recursively partitioned into sub-CUs a given number of times, wherein the number of times the CU can be partitioned may be indicated as a maximum CU partition level, or maximum CU partition depth.

Each level of partitioning may be associated with a particular level value, starting with level 0 corresponding to the LCU level. In the example of FIG. 4A, CU 400 may correspond to an LCU, and the partition level of CU 400 may have a value of “0,” indicating that CU 400 corresponds to an LCU. Similarly, a partition level for sub-CUs 402, 404, 406, and 408 corresponds to level 1, a partition level for sub-CUs 410, 412, 414, and 416 corresponds to level 2, and a partition level for sub-CUs 418, 420, 422, and 424 corresponds to level 3.

FIG. 4B illustrates an example of a quadtree data structure 426 for corresponding to the example of block 400 of FIG. 4A. As shown in FIG. 4B, quadtree 426 includes root node 428 which corresponds to level 0 (that is, LCU 400), terminal or “leaf” nodes with no child nodes 430, 434, 436, 438, 440, 444, 446, 448, 450, and 452, and intermediate nodes 432 and 444 having four child nodes. In this example, root node 428 has four child nodes, including three leaf nodes 430, 434, and 436, and one intermediate node 432. In this example, nodes 430, 432, 434, and 436 correspond to sub-CUs 402, 404, 406, and 408, respectively. Because node 432 is not a leaf node, node 432 includes four child nodes, which, in this example, includes three leaf nodes 438, 440, and 442, and one intermediate node 444. In this example, nodes 438, 440, 442, and 444 correspond to sub-CUs 410, 412, 414, and 416, respectively. Intermediate node 444 includes leaf nodes 446, 448, 450, and 452, which respectively correspond to sub-CUs 418, 420, 422, and 424, in this example. In general, a quadtree data structure for a given block of video data may contain more or fewer levels than the example of quadtree 426.

Additionally, each node of quadtree 426 may include syntax information describing whether a CU corresponding to the node is partitioned. Syntax information indicating whether the CU is partitioned may comprise an indicator, such as a split flag described above. A split flag may be a 1-bit value, e.g., a 1-bit flag. In some examples, video encoder 20 sets the one-bit flag to a value of ‘0’ to indicate that a corresponding CU is not partitioned, while if the CU is partitioned, video encoder 20 may indicate that the CU is partitioned by setting the value of the split flag value equal to “1.” In accordance with the techniques of this disclosure, video encoder 20 may jointly code the split flags for a group of coding units, e.g., four coding units corresponding to child nodes of a common parent node in a corresponding quadtree data structure. For example, video encoder 20 may jointly code split flags for sub-CUs 402, 404, 406, and 408. In some examples, video encoder 20 may jointly code split flags for any number of partition levels. Thus, in some examples, video encoder 20 may select a single value to represent the split flags for nodes at each of levels 0, 1, 2, and 3 of quadtree 426.

As one example, with reference to LCU 400 of FIG. 4A and quadtree 426 of FIG. 4B, video encoder 20 may jointly code partition information for sub-CUs 402, 404, 406, and 408 of LCU 400. Rather than including split flags in nodes 430, 432, 434, and 436 separately, video encoder 20 may instead include a value, e.g., in node 428, or in one of the nodes 430, 432, 434, and 436, to jointly represent the partitioning of sub-CUs 402, 404, 406, and 408.

In this example, partition information for sub-CUs 402, 404, 406, and 408 would indicate that sub-CUs 402, 406, and 408 are not partitioned, and that sub-CU 404 is partitioned. Video encoder 20 may select a VLC table based on a context for CU 400, e.g., based on a partition level for CU 400 (level 0, in this example), and/or whether neighboring CUs (not illustrated in this example) to CU 400 are partitioned. Video encoder 20 may then select a codeword from the selected table, such that the selected codeword indicates the partitioning information for the sub-CUs. Thus, the selected codeword would, in this example, indicate that the upper-left sub-CU (sub-CU 402, in this example) is not partitioned, the upper-right sub-CU (sub-CU 404, in this example) is partitioned, the lower-left sub-CU (sub-CU 406, in this example) is not partitioned, and the lower-right sub-CU (sub-CU 408, in this example) is not partitioned. Additionally in a similar manner, video encoder 20 may select a codeword representing partitioning information for lower levels, e.g., sub-CUs 410, 412, 414, 416, 418, 420, 422, and 424.

As another example, video encoder 20 may run-length encode split flags for CU 400 and sub-CUs thereof. For example, video encoder 20 may generate a set of split flags for CU 400 and the sub-CUs thereof, such that the set of split flags are arranged in breadth-first order with respect to quadtree 426. Breadth-first order generally refers to moving from left-to-right across all nodes of a level before moving to nodes of a lower level (where, in this example, “lower level” refers to a level value with a larger numeric value). In the example of FIGS. 4A and 4B, video encoder 20 may form a breadth-first sequence from the split flags for the CU and sub-CU, which in this example may be “1010000010000.” Video encoder 20 may then run-length encode the sequence, e.g., to form a value representing runs of 1's and 0's in the sequence.

In this manner, according to the techniques of this disclosure, partition information for a plurality of CUs may be jointly coded using, e.g., VLC or RLC coding techniques. These techniques may encode the partition information relatively more efficiently than separately providing individual split flags for each CU.

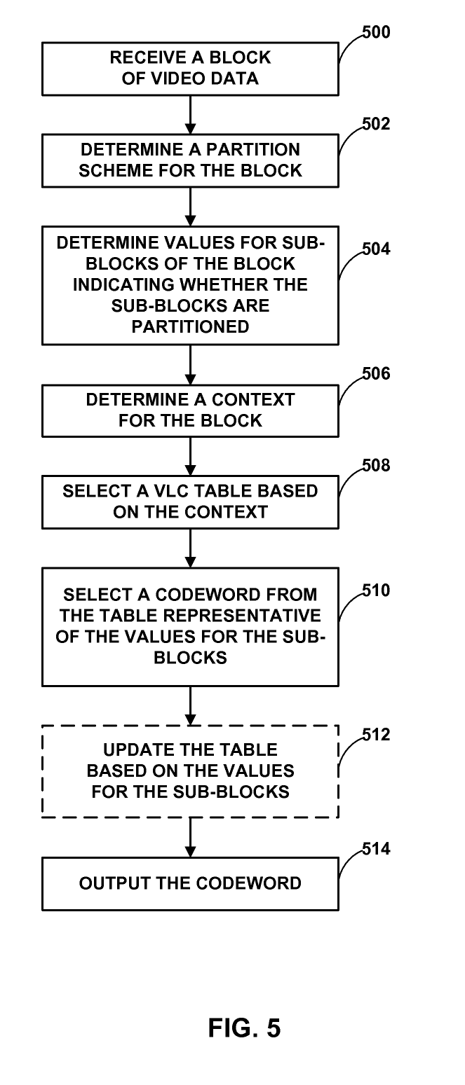

FIG. 5 is a flowchart illustrating an example method for jointly encoding partition information for multiple blocks of video data. The techniques of FIG. 5 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 5 are described with respect to video encoder 20 (FIGS. 1 and 2), although it should be understood that other devices may be configured to perform similar techniques. Moreover, the steps illustrated in FIG. 5 may be performed in a different order or in parallel, and additional steps may be added and certain steps omitted, without departing from the techniques of this disclosure.

Initially, video encoder 20 may receive a block of video data (500). The block may correspond to a CU, such as an LCU or a sub-CU. In this manner, the method of FIG. 5 may be applied recursively to sub-CUs of a CU, which may comprise an LCU. Video encoder 20 may further determine a partition structure for the block (502). For example, video encoder 20 may determine whether to partition the block into sub-blocks, and, after partitioning the block into sub-blocks, whether to partition the sub-blocks into further sub-blocks. In some examples, this partition information may be determined as part of selecting an encoding mode for the block, e.g., by mode select unit 40 in conjunction with one or more of motion estimation unit 42, motion compensation unit 44, and intra prediction unit 46. Assuming for purposes of example that video encoder 20 partitions the block into sub-blocks, video encoder 20 may further determine values for the sub-blocks indicating whether the sub-blocks are partitioned (504). For example, video encoder 20 may determine values for split flags of the sub-blocks that indicate whether the sub-blocks are partitioned into further sub-blocks. A split flag value of “1” may indicate that a corresponding sub-block is partitioned into four further sub-blocks, and a split flag value of “0” may indicate that the sub-block is not partitioned into further sub-blocks.

Video encoder 20 may determine the partition structure for the block and the corresponding values for the sub-blocks during a prediction phase of encoding the block. Video encoder 20 may attempt various partitioning schemes and prediction schemes to determine a combination of partitioning and prediction schemes that yields acceptable rate-distortion results. For example, in the case of intra-coding, intra-prediction unit 46 may generate one or more prediction blocks using spatial prediction, e.g., relative to neighboring, previously coded blocks in the same frame or slice. In the case of inter-coding, motion estimation unit 42 and motion compensation unit 46 may generate the one or more prediction blocks using temporal prediction, e.g., relative to data in one or more previously coded frames or slices. In any case, video encoder 20 may further calculate a difference between the one or more prediction blocks and the block, partitioned according to the determined partition structure, to produce one or more residual blocks, which transform unit 52 and quantization unit 54 of video encoder 20 may then transform and quantize, respectively.

Video encoder 20 may further encode information representative of the partition structure. For example, mode selection unit 40 may provide the values representative of whether the sub-blocks are partitioned to entropy coding unit 56. Entropy coding unit 56, or another unit of video encoder 20, may determine an encoding context for the block (506). The encoding context for the block may include a partition level for the block, and/or whether neighboring blocks, such as a top-neighboring block and/or a left-neighboring block, are partitioned. Entropy coding unit 56 may select a VLC table based on the determined encoding context (508).

Entropy coding unit 56 may further select a codeword from the VLC table representative of the values for the sub-blocks (510). For example, as discussed above, entropy coding unit 56 may select a shortest (e.g., single bit) codeword when the values for the sub-blocks comprise the most likely values. On the other hand, entropy coding unit 56 may select a codeword other than the shortest codeword when the values are not the most likely values. For example, the selected codeword may have a length, e.g., in terms of a number of bits, that is inversely proportional to the likelihood of the values, i.e., likelihood of the encoded block being partitioned in a manner indicated by the values, where the relative likelihoods correspond to the determined encoding context for the block.

In some examples, entropy coding unit 56 may update the selected VLC table based on the values for the sub-blocks to reflect which values are more or less likely to occur (512). Finally, entropy coding unit 56 may output the selected codeword to the bitstream (514). For example, entropy coding unit 56 may include the codeword in a quadtree data structure for the original block of received video data, such that the codeword comprises a single value representative of whether sub-blocks of the block are partitioned. In this manner, video encoder 20 may jointly code information representative of whether sub-blocks of a parent block are partitioned, in that video encoder 20 may select a single value (e.g., a VLC codeword) to represent whether the sub-blocks are partitioned.

The example of FIG. 5 is discussed relative to the use of VLC to encode the values representative of whether the sub-blocks are partitioned. In other examples, video encoder 20 may encode values representative of whether the sub-blocks are partitioned (e.g., split flags) using run-length coding techniques. In such examples, entropy coding unit 56 may encode values for any or all sub-blocks of a parent block (which may comprise an LCU or a sub-CU of an LCU) representative of whether corresponding sub-CUs are partitioned, and then output a resulting run-length code into the bitstream. Accordingly, the use of run-length coding is another example of jointly coding information representative of whether sub-blocks of a parent block are partitioned, in that video encoder 20 may calculate a single value (e.g., a run-length code) to represent whether the sub-blocks are partitioned.

In some examples, run-length coding and VLC codewords may be combined. For example, video encoder 20 may be configured to run-length encode split flags for an LCU, (that is, partition information for level 0 of the quadtree), but use VLC codewords to encode split flags for sub-CUs and further sub-CUs (that is, partition information for levels 1, 2 and beyond). Other combinations of these techniques, or other techniques for encoding partition information for a group of sub-blocks, are also possible. Moreover, the single value may represent multiple levels of sub-blocks.

In this manner, the method of FIG. 5 represents an example of a method including partitioning a CU of video data into a plurality of sub-CUs, determining whether to partition the sub-CUs into further sub-CUs, and encoding the CU to include a value that indicates whether the sub-CUs are partitioned into the further sub-CUs.

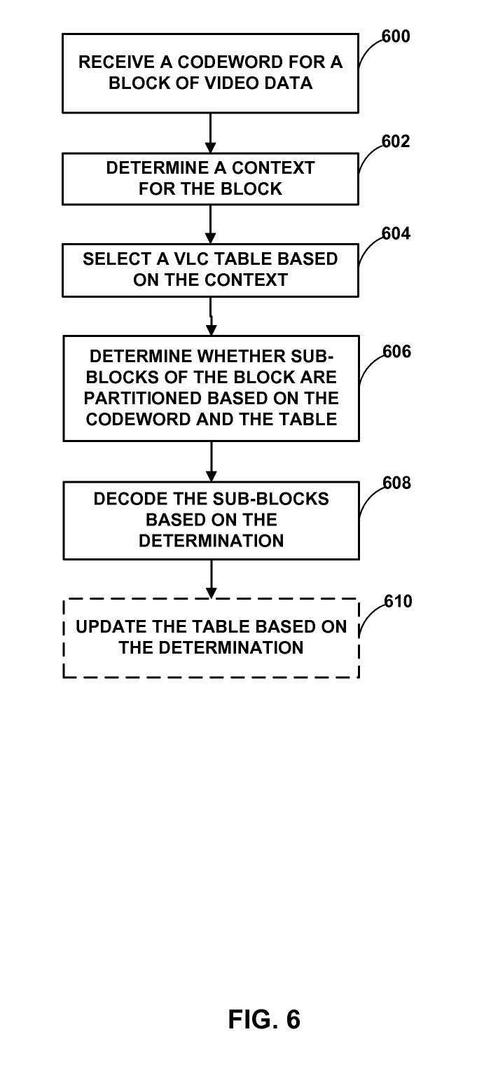

FIG. 6 is a flowchart illustrating an example method for decoding jointly encoded partition information for multiple blocks of video data. Again, the techniques of FIG. 6 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 6 are described with respect to video decoder 30 (FIGS. 1 and 3), although it should be understood that other devices may be configured to perform similar techniques. Moreover, the steps illustrated in FIG. 6 may be performed in a different order or in parallel, and additional steps may be added and certain steps omitted, without departing from the techniques of this disclosure.

Video decoder 30 may receive a codeword for a block of video data (600). Of course, video decoder 30 may also receive other data for the block, e.g., quantized transform coefficients and/or block header data indicating a prediction mode for the block. The block may correspond to an LCU, a CU of an LCU, or a sub-CU of a CU, and the codeword may comprise a VLC codeword, or another value (such as a run-length coded value). Video decoder 30 may further determine a context for the block (602). Entropy decoding unit 70 may determine a decoding context for the block in a substantially similar manner as described above with reference to FIG. 5. For example, entropy decoding unit 70 may determine a decoding context for the block based on any or all of a partition depth for the block, and/or whether neighboring blocks to the block are partitioned.

Likewise, entropy decoding unit 70 may further select a VLC table based on the determined decoding context for the block (604). Furthermore, video decoder 30 may determine whether sub-blocks of the block are partitioned based on the codeword and the VLC table (606). Because the VLC tables of video decoder 30 may be substantially similar to VLC tables of video encoder 20, video decoder 30 may select the same VLC table used by video encoder 20, and determine whether the sub-CUs of the CU are partitioned based on the partition values that are mapped to the received codeword in the VLC table. As also described above, the received codeword may have a length that is inversely proportional to the likelihood of the partitioning scheme based on the context, that is, the likelihood that the sub-blocks of the received block are partitioned in a particular manner.

The number of possible partition information values (i.e., the number of entries in a VLC table) may be relatively large, e.g., depending on the number of sub-blocks of a given block. For example, there may be four sub-blocks for a particular block when the block is partitioned according to a quadtree data structure, when only one level of the quadtree is considered. In this example, the corresponding VLC table may contain 16 different partition information entries (for each of the sixteen possible combinations of values for the four sub-blocks) corresponding to 16 different codewords (e.g., “1,” “01,” and so on).

As described above, in some examples, video encoder 20 may jointly code split flags for multiple levels of sub-blocks, and likewise, video decoder 30 may determine partitioning information for multiple levels of sub-blocks using a single received value. That is, in some examples, the partition information may correspond to sub-blocks across multiple levels of a quadtree data structure. Furthermore, as discussed above, in some examples, RLC coded values may be used to represent certain levels of blocks (e.g. Level 0 corresponding to the LCU), while VLC codewords may be used to represent remaining levels of sub-blocks (e.g., levels 1, 2 and beyond corresponding to sub-CUs of the LCU). Because VLC codewords may have lengths that are inversely proportional to the likelihoods of the corresponding partition information, in accordance with the techniques of this disclosure, these techniques may yield a relative bit savings over an entire bitstream, assuming that the likelihoods are determined accurately when using the codewords to code the partition information.

In some examples, the codeword may comprise a run-length coded value, and entropy decoding unit 70 may run-length decode the run-length coded value using RLC coding techniques to determine the partition information for the sub-blocks of the block. In such cases, because RLC codes may have lengths that are shorter than the fixed length values representing the partition information, the techniques of this disclosure may yield a relative bit savings over an entire bitstream.

In this manner, the method of FIG. 6 represents an example of a method of decoding video data, including receiving a value for a CU of video data, wherein the CU is partitioned into a plurality of sub-CUs, determining whether the sub-CUs are partitioned into further sub-CUs based on the value, and decoding the sub-CUs and the further sub-CUs.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of decoding video data, the method comprising:
receiving a value for a coding unit of video data, wherein the coding unit is partitioned into a plurality of sub-coding units;
determining whether the sub-coding units are partitioned into further sub-coding units based on the value; and
decoding the sub-coding units and the further sub-coding units.

2. The method of claim 1, wherein the value comprises a codeword, and wherein determining whether the sub-coding units are partitioned comprises:
selecting a variable length code table for the coding unit; and
determining whether the selected variable length code table indicates that the codeword represents that the sub-coding units are partitioned into the further sub-coding units.

3. The method of claim 2, wherein selecting the variable length code table comprises selecting the variable length code table based on a context for the coding unit, wherein the context comprises at least one of a partition level for the coding unit, and, when the coding unit comprises one or more neighboring coding units, whether the neighboring coding units are partitioned.

4. The method of claim 3, wherein the context comprises whether neighboring coding units having sizes that are equal to sizes of the sub-coding units of the coding unit are partitioned, and wherein when the coding unit has at least one neighboring coding unit that is not partitioned and that has a size that is greater than the size of the sub-coding units, the method comprises determining, for the context, that sub-coding units of the at least one neighboring coding unit having the sizes equal to the sizes of the sub-coding units of the coding unit are not partitioned.

5. The method of claim 2, further comprising updating the selected variable length code table based on whether the sub-coding units are partitioned into the further sub-coding units.

6. The method of claim 1, wherein the value comprises a run-length coded value, and wherein determining whether the sub-coding units are partitioned comprises:
decoding the run-length coded value to produce a set of split flags for the sub-coding units; and
determining whether the sub-coding units are partitioned into the further sub-coding units based on the respective split flags for the sub-coding units.

7. The method of claim 1, further comprising determining whether the further sub-coding units are partitioned based on the value.

8. An apparatus for decoding video data, the apparatus comprising a video decoder configured to receive a value for a coding unit of video data, wherein the coding unit is partitioned into a plurality of sub-coding units, determine whether the sub-coding units are partitioned into further sub-coding units based on the value, and decode the sub-coding units and the further sub-coding units.

9. The apparatus of claim 8, wherein the value comprises a codeword, and wherein to determine whether the sub-coding units are partitioned, the video decoder is configured to select a variable length code table for the coding unit, and determine whether the selected variable length code table indicates that the codeword represents that the sub-coding units are partitioned into the further sub-coding units.

10. The apparatus of claim 9, wherein the video decoder is configured to select the variable length code table based on a context for the coding unit, wherein the context comprises at least one of a partition level for the coding unit, and, when the coding unit comprises one or more neighboring coding units, whether the neighboring coding units are partitioned.

11. The apparatus of claim 10, wherein the context comprises whether neighboring coding units having sizes that are equal to sizes of the sub-coding units of the coding unit are partitioned, and wherein the video decoder is configured to, when the coding unit has at least one neighboring coding unit that is not partitioned and that has a size that is greater than the size of the sub-coding units, determine, for the context, that sub-coding units of the at least one neighboring coding unit having the sizes equal to the sizes of the sub-coding units of the coding unit are not partitioned.

12. The apparatus of claim 8, wherein the value comprises a run-length coded value, and wherein to determine whether the sub-coding units are partitioned, the video decoder is configured to decode the run-length coded value to produce a set of split flags for the sub-coding units, and determine whether the sub-coding units are partitioned into the further sub-coding units based on the respective split flags for the sub-coding units.

13. The apparatus of claim 8, wherein the video decoder is configured to determine whether the further sub-coding units are partitioned based on the value.

14. The apparatus of claim 8, wherein the apparatus comprises at least one of:
an integrated circuit;
a microprocessor; and
a wireless communication device that includes the video decoder.

15. An apparatus for decoding video data, the apparatus comprising:
means for receiving a value for a coding unit of video data, wherein the coding unit is partitioned into a plurality of sub-coding units;
means for determining whether the sub-coding units are partitioned into further sub-coding units based on the value; and
means for decoding the sub-coding units and the further sub-coding units.

16. The apparatus of claim 15, wherein the value comprises a codeword, and wherein the means for determining whether the sub-coding units are partitioned comprises:
means for selecting a variable length code table for the coding unit; and
means for determining whether the selected variable length code table indicates that the codeword represents that the sub-coding units are partitioned into the further sub-coding units.

17. The apparatus of claim 16, wherein the means for selecting the variable length code table comprises means for selecting the variable length code table based on a context for the coding unit, wherein the context comprises at least one of a partition level for the coding unit, and, when the coding unit comprises one or more neighboring coding units, whether the neighboring coding units are partitioned.

18. The apparatus of claim 17, wherein the context comprises whether neighboring coding units having sizes that are equal to sizes of the sub-coding units of the coding unit are partitioned, and wherein the apparatus comprises means for, when the coding unit has at least one neighboring coding unit that is not partitioned and that has a size that is greater than the size of the sub-coding units, determining, for the context, that sub-coding units of the at least one neighboring coding unit having the sizes equal to the sizes of the sub-coding units of the coding unit are not partitioned.

19. The apparatus of claim 15, wherein the value comprises a run-length coded value, and wherein the means for determining whether the sub-coding units are partitioned comprises:
means for decoding the run-length coded value to produce a set of split flags for the sub-coding units; and
means for determining whether the sub-coding units are partitioned into the further sub-coding units based on the respective split flags for the sub-coding units.

20. A computer program product comprising a computer-readable medium having stored thereon instructions that, when executed, cause a processor to:
receive a value for a coding unit of video data, wherein the coding unit is partitioned into a plurality of sub-coding units;
determine whether the sub-coding units are partitioned into further sub-coding units based on the value; and
decode the sub-coding units and the further sub-coding units.

21. The computer program product of claim 20, wherein the value comprises a codeword, and wherein the instructions that cause the processor to determine whether the sub-coding units are partitioned comprise instructions that cause the processor to:
select a variable length code table for the coding unit; and
determine whether the selected variable length code table indicates that the codeword represents that the sub-coding units are partitioned into the further sub-coding units.

22. The computer program product of claim 21, wherein the instructions that cause the processor to select the variable length code table comprise instructions that cause the processor to select the variable length code table based on a context for the coding unit, wherein the context comprises at least one of a partition level for the coding unit, and, when the coding unit comprises one or more neighboring coding units, whether the neighboring coding units are partitioned.

23. The computer program product of claim 22, wherein the context comprises whether neighboring coding units having sizes that are equal to sizes of the sub-coding units of the coding unit are partitioned, further comprising instructions that cause the processor to determine, when the coding unit has at least one neighboring coding unit that is not partitioned and that has a size that is greater than the size of the sub-coding units, for the context, that sub-coding units of the at least one neighboring coding unit having the sizes equal to the sizes of the sub-coding units of the coding unit are not partitioned.

24. The computer program product of claim 20, wherein the value comprises a run-length coded value, and wherein the instructions that cause the processor to determine whether the sub-coding units are partitioned comprises instructions that cause the processor to:
decode the run-length coded value to produce a set of split flags for the sub-coding units; and
determine whether the sub-coding units are partitioned into the further sub-coding units based on the respective split flags for the sub-coding units.

25. The computer program product of claim 20, further comprising instructions that cause the processor to determine whether the further sub-coding units are partitioned based on the value.

26. A method of encoding video data, the method comprising:
partitioning a coding unit of video data into a plurality of sub-coding units;
determining whether to partition the sub-coding units into further sub-coding units; and
encoding the coding unit to include a value that indicates whether the sub-coding units are partitioned into the further sub-coding units.

27. The method of claim 26, wherein the value comprises a codeword, and wherein encoding the coding unit to include the value comprises:
selecting a variable length code table for the coding unit; and
selecting the codeword from the variable length code table, wherein the variable length code table indicates that the codeword represents whether the sub-coding units are partitioned into the further sub-coding units.

28. The method of claim 27, wherein selecting the variable length code table comprises selecting the variable length code table based on a context for the coding unit, wherein the context comprises at least one of a partition level for the coding unit, and, when the coding unit comprises one or more neighboring coding units, whether the neighboring coding units are partitioned.

29. The method of claim 28, wherein the context comprises whether neighboring coding units having sizes that are equal to sizes of the sub-coding units of the coding unit are partitioned, and wherein when the coding unit has at least one neighboring coding unit that is not partitioned and that has a size that is greater than the size of the sub-coding units, the method comprises determining, for the context, that sub-coding units of the at least one neighboring coding unit having the sizes equal to the sizes of the sub-coding units of the coding unit are not partitioned.

30. The method of claim 27, further comprising updating the selected variable length code table based on whether the sub-coding units are partitioned into the further sub-coding units.

31. The method of claim 26, wherein the value comprises a run-length coded value, and wherein encoding the coding unit to include the run-length code comprises:
forming a set of split flags for the sub-coding units, wherein the split flags indicate whether the respective sub-coding units are partitioned; and
run-length encoding the set of split flags to form the run-length coded value.

32. The method of claim 26, wherein encoding the coding unit to include the value further comprises encoding the coding unit such that the value indicates whether the sub-coding units are partitioned into the further sub-coding units and whether the further sub-coding units are partitioned.

33. An apparatus for encoding video data, the apparatus comprising a video encoder configured to partition a coding unit of video data into a plurality of sub-coding units, determine whether to partition the sub-coding units into further sub-coding units, and encode the coding unit to include a value that indicates whether the sub-coding units are partitioned into the further sub-coding units.

34. The apparatus of claim 33, wherein the value comprises a codeword, and wherein to encode the coding unit to include the value, the video encoder is configured to select a variable length code table for the coding unit, and select the codeword from the variable length code table, wherein the variable length code table indicates that the codeword represents whether the sub-coding units are partitioned into the further sub-coding units.

35. The apparatus of claim 34, wherein to select the variable length code table, the video encoder is configured to select the variable length code table based on a context for the coding unit, wherein the context comprises at least one of a partition level for the coding unit, and, when the coding unit comprises one or more neighboring coding units, whether the neighboring coding units are partitioned.

36. The apparatus of claim 35, wherein the context comprises whether neighboring coding units having sizes that are equal to sizes of the sub-coding units of the coding unit are partitioned, and wherein the video encoder is configured to determine, for the context, when the coding unit has at least one neighboring coding unit that is not partitioned and that has a size that is greater than the size of the sub-coding units, that sub-coding units of the at least one neighboring coding unit having the sizes equal to the sizes of the sub-coding units of the coding unit are not partitioned.

37. The apparatus of claim 33, wherein the value comprises a run-length coded value, and wherein to encode the coding unit to include the run-length code, the video encoder is configured to form a set of split flags for the sub-coding units, wherein the split flags indicate whether the respective sub-coding units are partitioned, and run-length encode the set of split flags to form the run-length coded value.

38. The apparatus of claim 33, wherein encoding the coding unit to include the value further comprises encoding the coding unit such that the value indicates whether the sub-coding units are partitioned into the further sub-coding units and whether the further sub-coding units are partitioned.

39. The apparatus of claim 33, wherein the apparatus comprises at least one of:
an integrated circuit;
a microprocessor; and
a wireless communication device that includes the video encoder.

40. An apparatus for encoding video data, the apparatus comprising:
means for partitioning a coding unit of video data into a plurality of sub-coding units;
means for determining whether to partition the sub-coding units into further sub-coding units; and
means for encoding the coding unit to include a value that indicates whether the sub-coding units are partitioned into the further sub-coding units.

41. The apparatus of claim 26, wherein the value comprises a codeword, and wherein the means for encoding the coding unit to include the value comprises:
means for selecting a variable length code table for the coding unit; and
means for selecting the codeword from the variable length code table, wherein the variable length code table indicates that the codeword represents whether the sub-coding units are partitioned into the further sub-coding units.

42. The apparatus of claim 41, wherein the means for selecting the variable length code table comprises means for selecting the variable length code table based on a context for the coding unit, wherein the context comprises at least one of a partition level for the coding unit, and, when the coding unit comprises one or more neighboring coding units, whether the neighboring coding units are partitioned.

43. The apparatus of claim 42, wherein the context comprises whether neighboring coding units having sizes that are equal to sizes of the sub-coding units of the coding unit are partitioned, further comprising means for determining, for the context, when the coding unit has at least one neighboring coding unit that is not partitioned and that has a size that is greater than the size of the sub-coding units, that sub-coding units of the at least one neighboring coding unit having the sizes equal to the sizes of the sub-coding units of the coding unit are not partitioned.

44. The apparatus of claim 40, wherein the value comprises a run-length coded value, and wherein the means for encoding the coding unit to include the run-length code comprises:
means for forming a set of split flags for the sub-coding units, wherein the split flags indicate whether the respective sub-coding units are partitioned; and
means for run-length encoding the set of split flags to form the run-length coded value.

45. A computer program product comprising a computer-readable storage medium having stored thereon instructions that, when executed, cause a processor to:
partition a coding unit of video data into a plurality of sub-coding units;
determine whether to partition the sub-coding units into further sub-coding units; and
encode the coding unit to include a value that indicates whether the sub-coding units are partitioned into the further sub-coding units.

46. The computer program product of claim 45, wherein the value comprises a codeword, and wherein the instructions that cause the processor to encode the coding unit to include the value comprise instructions that cause the processor to:
select a variable length code table for the coding unit; and
select the codeword from the variable length code table, wherein the variable length code table indicates that the codeword represents whether the sub-coding units are partitioned into the further sub-coding units.

47. The computer program product of claim 46, wherein the instructions that cause the processor to select the variable length code table comprise instructions that cause the processor to select the variable length code table based on a context for the coding unit, wherein the context comprises at least one of a partition level for the coding unit, and, when the coding unit comprises one or more neighboring coding units, whether the neighboring coding units are partitioned.

48. The computer program product of claim 47, wherein the context comprises whether neighboring coding units having sizes that are equal to sizes of the sub-coding units of the coding unit are partitioned, further comprising instructions that cause the processor to determine, for the context, when the coding unit has at least one neighboring coding unit that is not partitioned and that has a size that is greater than the size of the sub-coding units, that sub-coding units of the at least one neighboring coding unit having the sizes equal to the sizes of the sub-coding units of the coding unit are not partitioned.

49. The computer program product of claim 45, wherein the value comprises a run-length coded value, and wherein the instructions that cause the processor to encode the coding unit to include the run-length code comprise instructions that cause the processor to:
form a set of split flags for the sub-coding units, wherein the split flags indicate whether the respective sub-coding units are partitioned; and
run-length encode the set of split flags to form the run-length coded value.

50. The computer program product of claim 45, wherein the instructions that cause the processor to encode the coding unit to include the value further comprise instructions that cause the processor to encode the coding unit such that the value indicates whether the sub-coding units are partitioned into the further sub-coding units and whether the further sub-coding units are partitioned.
